(19) United States
(12) Patent Application Publication
(10) Pub. No.: US 2025/0070960 A1
(43) Pub. Date: Feb. 27, 2025

(54) ELECTRONIC DEVICE AND ENCRYPTION METHOD

(71) Applicant: CRYPTO LAB INC., Seoul (KR)

(72) Inventors: Junbum SHIN, Suwon-si (KR); Seewoo LEE, Seoul (KR); Unyoung KIM, Seoul (KR); Igjae KIM, Tongyeong-si (KR)

(21) Appl. No.: 18/721,020

(22) PCT Filed: Dec. 19, 2022
(86) PCT No.: PCT/KR2022/020685

§ 371 Date: Jun. 17, 2024

(30) Foreign Application Priority Data
Dec. 17, 2021 (KR) 10-2021-0182226
Dec. 1, 2022 (KR) 10-2022-0165867

(51) Int. Cl. H04L 9/08; H04L 9/00; H04L 9/32

(52) U.S. Cl. CPC H04L 9/0825; H04L 9/008; H04L 9/0861; H04L 9/3247

(57) ABSTRACT

An electronic device is disclosed. The present electronic device comprises: a communication device for communicating with an external device; a memory for storing data; and a processor for supporting a trusted execution environment (TEE) function, wherein the processor is configured to store a received open software in a protection zone corresponding to the TEE function, when the open software, signature information corresponding to the open software, and hash information corresponding to the open software are received from the external device, generate a secret key corresponding to the open software, and perform an operation corresponding to the open software by using the open software and the data, stored in the protection zone.

### TECHNICAL FIELD

The present disclosure relates to an electronic device and an encryption method, and more particularly, to an electronic device which may prevent internal data leakage from a central processing unit (CPU) supporting a trusted execution environment (TEE) function, and an encryption method.

### BACKGROUND ART

A trusted execution environment (TEE) function is a technology for controlling an operation not based on software but based on hardware, and is an architecture extension designed to increase software security.

In detail, the TEE function may be the technology in which a user sets a protection zone, and a central processing unit (CPU) thus encrypts a portion of a memory, thereby ensuring data in the protection zone not to be accessed by any program other than a program executed in the protection zone.

Accordingly, information in the protection zone of an application and data on a platform to which the TEE is applied may be safe even though an operating system (OS) is hacked by an external attack.

In this way, the TEE function may provide safe protection. However, the above-described function may become useless in case that the application stored on the platform includes a malicious function.

### DISCLOSURE

### Technical Problem

The present disclosure provides an electronic device which may prevent internal data leakage from a central processing unit (CPU) supporting a trusted execution environment (TEE) function, and an encryption method.

### Technical Solution

According to an embodiment of the present disclosure, provided is an electronic device including: a communication device configured to communicate with an external device; a memory storing data; and a processor configured to support a trusted execution environment (TEE) function, wherein the processor is configured to store a received open software in a protection zone corresponding to the TEE function, when the open software, signature information corresponding to the open software, and hash information corresponding to the open software are received from the external device, generate a secret key corresponding to the open software, and perform an operation corresponding to the open software by using the open software and the data, stored in the protection zone.

The processor may be configured to classify the secret key into a first secret key and a second secret key, encrypt the first secret key by using a private key, store the encrypted the first secret, encrypt the second secret key by using the signature information, and store the encrypted the second secret key.

The secret key may be calculated by an XOR operation performed on the first secret key and the second secret key.

The processor may be configured to encrypt a received private key by using the TEE function, and store the encrypted private key in the protection zone.

The processor may be configured to encrypt an operation result corresponding to the open software by using the secret key.

The processor may be configured to control the communication device to transmit the encrypted operation result and encryption key information corresponding to the secret key.

The encryption key information may include first data acquired by encrypting the first secret key included in the secret key by using a private key, and second data acquired by encrypting the second secret key included in the secret key by using the signature information.

The processor may be configured to store the encrypted operation result and information on the open software in the memory.

The processor may be configured to compare the information on the open software corresponding to a ciphertext with software for performing the operation in case that the data used by the open software is stored in the memory in a form of the ciphertext, and decrypt the ciphertext by using the secret key in case that the two software are the same software.

The processor may be configured to check integrity of the open software when the open software is received, and generate the secret key in case of confirming the integrity.

The processor may be configured to perform an operation command by using homomorphic operation corresponding to a homomorphic ciphertext in case of receiving the operation command using non-open software.

According to an embodiment of the present disclosure, provided is an encryption method of an electronic device which includes a processor configured to support a trusted execution environment (TEE) function, the method including: receiving, from an external device, an open software, signature information corresponding to the open software, and hash information corresponding to the open software; storing the received open software in a protection zone corresponding to the TEE function; generating a secret key corresponding to the open software; and performing an operation corresponding to the open software by using the open software and data, stored in the protection zone.

The method may further include encrypting an operation result corresponding to the open software by using the secret key.

The method may further include transmitting the encrypted operation result and encryption key information corresponding to the secret key.

The encryption key information may include first data acquired by encrypting a first secret key included in the secret key by using a private key, and second data acquired by encrypting a second secret key included in the secret key by using the signature information.

The method may further include storing the encrypted operation result and information on the open software in a memory.

The method may further include: comparing the information on the open software corresponding to a ciphertext with software for performing the operation in case that the data used by the open software is stored in the memory in a form of the ciphertext; and decrypting the ciphertext by using the secret key in case that the two software are the same software.

The method may further include checking integrity of the open software when the open software is received.

### Advantageous Effects

As set forth above, according to the various embodiments of the present disclosure, the quantum-resistant encryption may still be performed even by using the existing legacy authentication certificate.

### DESCRIPTION OF DRAWINGS

The above or other aspects, features, or benefits of embodiments in the present disclosure will be more apparent by the description provided below with reference to the accompanying drawings, in which:

FIG. 1 is a diagram for explaining a trusted execution environment (TEE) function of the present disclosure;

FIG. 2 is a diagram for explaining a configuration of an electronic device according to an embodiment of the present disclosure;

FIG. 3 is a diagram for explaining a detailed configuration of a processor of the present disclosure;

FIG. 4 is a sequence diagram for explaining an embodiment of using an open code according to the present disclosure;

FIG. 5 is a flowchart for explaining an encryption method according to an embodiment of the present disclosure; and

FIG. 6 is a flow chart for explaining an encryption method according to an embodiment of the present disclosure.

### BEST MODE

### Mode

The present disclosure may be variously modified and have several embodiments, and specific embodiments of the present disclosure are thus illustrated in the drawings and described in detail in the detailed description. However, it is to be understood that the scope of the present disclosure is not limited to the specific embodiments, and includes various modifications, equivalents and/or alternatives according to the embodiments of the present disclosure. Throughout the accompanying drawings, similar components are denoted by similar reference numerals.

In describing the present disclosure, omitted is a detailed description of a case where it is decided that a detailed description of the known functions or configurations related to the present disclosure may unnecessarily obscure the gist of the present disclosure.

In addition, the following embodiments may be modified in several different forms, and the scope and spirit of the present disclosure are not limited to the following embodiments. Rather, these embodiments are provided to make the present disclosure thorough and complete, and to completely deliver the spirit of the present disclosure to those skilled in the art.

Terms used in the present disclosure are used only to describe the specific embodiments rather than limiting the scope of the present disclosure. A term of a single number may include its plural number unless explicitly indicated otherwise in the context.

In the present disclosure, the expression “have”, “may have”, “include”, “may include” or the like, indicates the existence of a corresponding feature (for example, a numerical value, a function, an operation or a component such as a part), and does not exclude the existence of an additional feature.

In the present disclosure, an expression “A or B”, “at least one of A and/or B”, “one or more of A and/or B” or the like, may include all possible combinations of items enumerated together. For example, “A or B,” “at least one of A and B” or “at least one of A or B” may indicate all of 1) a case where at least one A is included, 2) a case where at least one B is included, or 3) a case where both of at least one A and at least one B are included.

Expressions “first”, “second” and the like, used in the present disclosure, may indicate various components regardless of the sequence and/or importance of the components. These expressions are used only to distinguish one component and another component from each other, and do not limit the corresponding components.

In case that any component (for example, a first component) is mentioned to be “(operatively or communicatively) coupled with/to” or “connected to” another component (for example, a second component), it is to be understood that any component is directly coupled to another component or coupled to another component through still another component (for example, a third component).

On the other hand, in case that any component (for example, the first component) is mentioned to be “directly coupled to” or “directly connected to” another component (for example, the second component), it is to be understood that still other component (for example, the third component) is not present between any component and another component.

An expression “configured (or set) to” used in the present disclosure may be replaced by an expression “suitable for”, “having the capacity to”, “designed to”, “adapted to”, “made to” or “capable of” based on a situation. The expression “configured (or set) to” may not necessarily indicate “specifically designed to” in hardware.

Instead, an expression “a device configured to” in any situation may indicate that the device may “perform˜” together with another device or component. For example, “a processor configured (or set) to perform A, B and C” may indicate a dedicated processor (for example, an embedded processor) that may perform the corresponding operations or a generic-purpose processor (for example, a central processing unit (CPU) or an application processor) that may perform the corresponding operations by executing one or more software programs stored in a memory device.

In the embodiments, a “module” or a “˜er/or” may perform at least one function or operation, and be implemented by hardware or software or be implemented by a combination of hardware and software. In addition, a plurality of “modules” or a plurality of “˜ers/ors” may be integrated with each other in at least one module and implemented by at least one processor except for a “module” or an “˜er/or” that needs to be implemented in specific hardware.

Operations performed by the modules, the programs or other components according to the various embodiments may be executed in a sequential manner, a parallel manner, an iterative manner or a heuristic manner, and at least some of the operations may be performed in a different order or be omitted, or other operations may be added.

Meanwhile, various elements and regions in the drawings are schematically shown. Therefore, the spirit of the present disclosure is not limited by relative sizes or intervals shown in the accompanying drawings.

Meanwhile, an electronic device and an external device according to various embodiments of the present disclosure may include, at least one of, for example, a television (TV), a monitor, a projector, a set-top box, a smartphone, a tablet personal computer (PC), a desktop PC, a laptop PC, or a wearable apparatus. The wearable device may include at least one of an accessory type (for example, a watch, a ring, a bracelet, an anklet, a necklace, a glasses, a contact lens, or a head-mounted-device (HMD)), a textile or clothing integral type (for example, an electronic clothing), a body attachment type (for example, a skin pad or a tattoo), or a living body implantation type circuit.

In addition, in the present disclosure, a “value” may be defined as a concept that includes a vector as well as a scalar value. In addition, in the present disclosure, an expression such as “calculate” or “compute” may be replaced with an expression of generating a result of the corresponding calculation or computation. In addition, unless otherwise specified, an operation on a ciphertext described below refers to a homomorphic operation. For example, addition of homomorphic ciphertexts may indicate homomorphic addition of two homomorphic ciphertexts.

Mathematical operations and calculations of each step in the present disclosure described below may be implemented as computer operations by a known coding method or coding designed to be suitable for the present disclosure to perform the corresponding operations or calculations.

Specific equations described below are exemplarily described among possible alternatives, and the scope of the present disclosure should not be construed as being limited to the equations mentioned in the present disclosure.

Hereinafter, the embodiments of the present disclosure will be described in detail with reference to the accompanying drawings so that those skilled in the art to which the present disclosure pertains may easily practice the present disclosure.

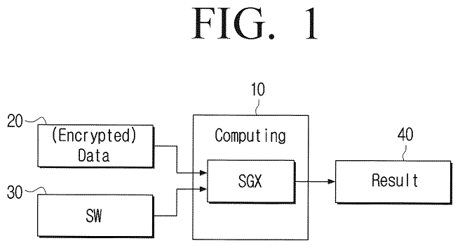

FIG. 1 is a diagram for explaining a trusted execution environment (TEE) function of the present disclosure.

Referring to FIG. 1, an electronic device 100 may support the TEE function. Here, the TEE function is a technology applied to a central processing unit (CPU) and related to security, and may also be referred to as software guard extension (SGX) or the like. Hereinafter, for ease of explanation, the SGX, which is an example of the TEE function, is described as an example, and a technology other than SGX may also be applied to the CPU. In detail, the TEE function is a technology in which a user sets a protection zone, and the central processing unit (CPU) thus encrypts a portion of a memory, thereby ensuring data in the protection zone not to be accessed by any program other than a program executed in the protection zone.

It is possible to specify the protection zone to thus protect important information such as a hardware encryption password, confidential information in a password management program, and an encryption key.

It is possible to use the TEE function in this way to thus encrypt and store the important information in the protection zone even if hacking occurs, thereby ensuring high safety. In addition, the above-described operations may be performed in a hardware manner, and thus have a fast operation capability.

However, the TEE function is operated using software 30 provided by an internal CPU manufacturer, and data leakage may thus be bound to occur due to internal security data 20 and an operation result 40 even though the TEE function is used if the software has a purpose of advertising data or data sales.

Meanwhile, recently, homomorphic encryption, which may be operated in a ciphertext state, is commercialized. In this regard, it is possible to solve the above-described problem by storing all the data by the homomorphic ciphertext, and also configuring a software operation as a homomorphic operation, to prevent the above-described leakage.

However, processing the data by the homomorphic ciphertext may have high security but a slow operation speed.

The present disclosure uses a homomorphic association training method to solve these problems of an existing technology.

In detail, the homomorphic association training of the present disclosure may open an operation code or use a method of processing the data by using homomorphic encryption processing to prevent a malicious operation of the manufacturer (or system software) that provides the TEE function even while using the same hardware configuration as shown in FIG. 1, that is, the TEE function.

In detail, software that may be open (for example, an encryption method or a decryption method) may be operated using the TEE by using an open algorithm (that is, open software). Such open software may be used to thus verify whether a malicious code is included. Alternatively, it is also possible to ensure safety of the software by uploading or managing the open software through a verified company or organization.

And software unable to be open may be processed using the homomorphic encryption. As described above, the data may have the high security in case of using the homomorphic encryption method. In this regard, it is impossible to access an original text (or a plaintext) of the data without a secret key, thus ensuring its safety even though the software that processes the ciphertext is operated with malicious content.

In this way, the present disclosure may prevent malicious data access from the internal software by using the open code and a homomorphic operation method together.

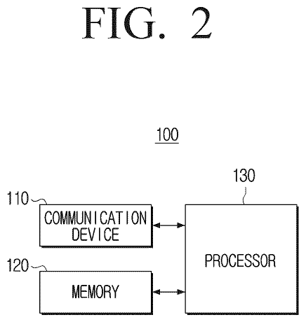

Hereinafter, the description describes the detailed configuration and operation of the electronic device using the above-described homomorphic association training with reference to FIG. 2.

FIG. 2 is a diagram for explaining a configuration of an electronic device according to an embodiment of the present disclosure.

Referring to FIG. 2, the electronic device 100 may include a communication device 110, a memory 120, and a processor 130.

The communication device 110 may connect the electronic device 100 to an external device (not shown), and may be connected to the external device not only through a local area network (LAN) or an Internet network, or but also through a universal serial bus (USB) port or a wireless communication (e.g., wireless fidelity (Wi-Fi) 802.11 a/b/g/n, near field communication (NFC), or Bluetooth) port. The communication device 110 may also be referred to as a transceiver.

The communication device 110 may receive the open software from the external device. Here, the communication device 110 may perform signature information and hash information, corresponding to the open software, together. Here, the open software is a program that stores instructions for performing various operations on the data, and may include various operation instructions for the data, such as an encryption algorithm, a decryption algorithm, and a statistical algorithm.

In addition, the signature information and the hash information may be information used to verify the open software. In detail, the hash information may be based on a source code of the open software, and may be open for anyone to acquire the same hash information by using the open software. In addition, the signature information may be used to verify software information and used for the encryption key information or software identification described below.

The communication device 110 may receive or transmit the secret key based on the identity (ID) generated by another device. In detail, the communication device 110 may communicate with a key generation device, transmit the hash information based on a source key of the software to the key generation device, and receive the ID-based secret key based on the transmitted hash information.

In addition, the communication device 110 may receive a message from the external device, and transmit the generated ciphertext to the external device. Here, the communication device 110 may transmit the encryption key information required for decrypting the ciphertext together with the generated ciphertext.

The memory 120 is a component storing an operating system (O/S), various software, data, and the like for driving the electronic device 100. The memory 120 may be implemented in various forms such as a random access memory (RAM), a read-only memory (ROM), a flash memory, a hard disk drive (HDD), an external memory, and a memory card, and is not limited to any one of these forms.

The memory 120 may store the message (or the plaintext) to be encrypted. Here, the message may be the various credit information, personal information or the like cited by the user, and may be information related to a usage history such as location information or internet usage time information, used by the electronic device 100.

In addition, the memory 120 may store various information such as received software, and store an intermediate operation result (e.g., quantum-resistant secret key or ID-based secret key) required in a process described below by the electronic device 100.

In addition, the memory 120 may store the ciphertext generated in the process described below. In addition, the memory 120 may also store the ciphertext transmitted from the external apparatus.

The memory 120 may include the protection zone. In detail, the memory 120 may include the protection zone corresponding to the TEE function, and store data requiring its security in the protection zone. In case that the data is stored in the protection zone, the data may be encrypted and stored based on the TEE function even though there is no separate user command.

The processor 130 may control each component in the electronic device 100. The processor 130 may include one device such as the central processing unit (CPU) or an application-specific integrated circuit (ASIC), or may include a plurality of devices such as the CPU, a graphics processing unit (GPU), and a trusted execution environment (TEE) device.

The processor 130 may determine a driving method of the electronic device 100. In detail, the processor 130 may determine whether an operation command requested by the user is based on the open software or a non-open software. As a determination result, in case that the command is based on the non-open software, the processor 130 may perform operation processing using the homomorphic encryption method as described above.

On the other hand, in case that the command is based on the open software, the processor 130 may determine whether the open software is installed in the electronic device 100. In case that the open software is installed in the electronic device 100, the processor 130 may perform the operation by using the predetermined open software. In case that the open software is not installed in the electronic device 100, the processor 130 may control the communication device 110 to receive the open software from the external device.

The processor 130 may receive, from the external device, the open software, the signature information corresponding to the open software, and the hash information corresponding to the open software. In detail, the open software described above may be stored in a verified storage (or the external device), and the processor 130 may control the communication device 110 to receive the software from the above-described storage. Here, the processor 130 may receive the signature information and the hash information for the verification of the above-described software.

In addition, the processor 130 may check integrity of the open software in case of receiving the open software, and generate the secret key in case of confirming the integrity. In detail, the processor 130 may perform the integrity check for the open software, and store the software in the memory 120 in case that there is no problem with the integrity check. In addition, the processor 130 may generate the secret key to be applied to the software.

In detail, the processor 130 may generate the secret key corresponding to the software or the TEE function by generating a first random key and a second random key, and performing an XOR operation on the generated first and second random keys.

Here, the processor 130 may control the communication device 110 to receive the ID-based secret key from a key management device. In case of receiving the ID-based secret key in this way, the processor 130 may encrypt the first random key (or the second random key) by using the ID-based secret key, encrypt the second random key by using a received signature key and individually store the same, and transmit, to the external device, the encrypted first random key and the encrypted second random key. In addition, the processor 130 may encrypt the received ID-based secret key by using the TEE function, and store the encrypted ID-based secret key in the protection zone of the memory 120.

The processor 130 may use the secret key to thus perform an operation of encrypting a result of an operation by the above-described software or decrypting the encrypted operation result.

The processor 130 may perform an operation corresponding to the open software by using the open software and the data, stored in the protection zone. Here, the processor 130 may perform the operation corresponding to the open software described above on the above-described data in a plaintext state. To this end, in case that there is encrypted data, the processor 130 may decrypt the data by using the secret key described above, and perform the operation on the data in a decrypted state. In addition, in case that the data is required to be stored, the processor 130 may encrypt the data by using the secret key described above, and store the encrypted data in the memory 120.

Here, the processor 130 may store the encryption operation result and information on the open software in the memory. Accordingly, in a process of using the encrypted and stored data, the processor 130 may compare the information on the open software corresponding to the ciphertext with software for performing the operation in case that the data used by the open software is stored in the memory in a form of the ciphertext, and decrypt the ciphertext by using the secret key in case that the two software are the same software.

The processor 130 may control the communication device to transmit the encrypted operation result and the encryption key information corresponding to the secret key. Here, the encryption key information may include first data acquired by encrypting a first secret key included in the secret key by using a private key, and second data acquired by encrypting a second secret key included in the secret key by using the signature information.

In this way, the present disclosure may encrypt the secret key by using two information (i.e., ID-based secret key and certificate information), that is, an encryption technique of utilizing two unrelated information, thus making the secret key quantum-resistant.

Meanwhile, the processor 130 may perform the operation command by using the homomorphic operation corresponding to the homomorphic ciphertext in case of receiving the operation command using the non-open software.

As described above, the electronic device 100 according to the present disclosure may safely protect user data not only from the hacking, but also from a malicious leakage by the malicious software having the purpose such as the advertising or the data sales.

Meanwhile, in showing and describing FIG. 2, the description shows and describes only a basic configuration of the electronic device 100. However, in implementation, the electronic device 100 may further include another component (for example, a display, an operation device, a camera, a speaker, or a microphone) in addition to the configuration described above. In addition, in the example shown above, the processor 130 is shown as one processor. However, in implementation, the processor 130 may include a plurality of processors. Alternatively, the processor 130 may be one processor 130, and include a multiple processor cores therein.

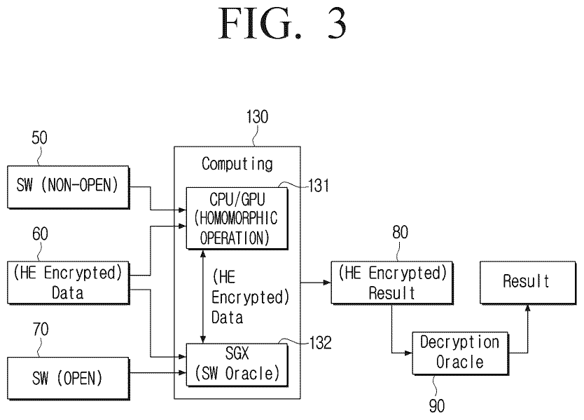

FIG. 3 is a diagram for explaining a detailed configuration of the processor of the present disclosure.

Referring to FIG. 3, the processor 130 may include a first processor core 131 and a second processor core 132.

The first processor core 131 may include a general CPU, GPU, or the like. In case of receiving the operation command using non-open software 50, the first processor core 131 may perform the operation processing on data 60 by using the homomorphic encryption method, and output an operation result 80.

The second processor core 132 may be a processor core performing the software guard extension (SGX) function, and in case of receiving the operation command using an open software 70, the second processor core 132 may perform the operation corresponding to the open software as described above. In addition, the second processor core 132 may encrypt the operation result by using the secret key, and output the operation result 80 in the encrypted state. Meanwhile, in the example shown above, the second processor core 132 is shown and described as using the SGX. However, in implementation, the second processor core 132 may use another TEE technology rather than the SGX.

The second processor core 132 may generate the secret key (or a master key). Here, the second processor core 132 may store the secret key described above by using the hybrid encryption method described above. In detail, the second processor core 132 may generate the secret key by performing the XOR operation on two random values. Here, the second processor core 132 may encrypt and store one of the two random values by using the ID-based secret key, and encrypt and store the other random value by using the signature information corresponding to the software. In addition, the above-described ID-based secret key may be stored by being encrypted using the SGX function. The second processor core 132 uses this secret key, and may thus be provided with a decryption function only in case of using the same software. That is, the decryption function is not operated due to a different secret key if the second processor core 132 makes a decryption request using another software.

Meanwhile, in case that the above-described application is updated, the second processor core 132 may receive the above-described operation such as the secret key generation again, delete the existing secret key, and generate and store the secret key corresponding to the updated application.

The output of the processor 130 in this way may be an output result using the open software or an output result of the homomorphic encryption. Therefore, it is possible for an electronic device 90 that verifies this output to use the output result in a manner based on the operation method.

For example, in the case of using the homomorphic encryption method, the electronic device 90 may decrypt the operation result by using the secret key corresponding to the homomorphic operation. In this case, the electronic device 90 may acquire the operation result. However, neither the processor 130 nor the electronic device 90 processes the data in the plaintext state, and it is thus possible to protect the data in the plaintext.

If using the SGX (or TEE) method, the electronic device 90 may receive the ciphertext and the encryption key information corresponding to the ciphertext. In detail, the electronic device 90 may restore the secret key by using the encryption key. For example, the electronic device 90 may receive the ID-based secret key from the key management device, and acquire the open software certificate information. In addition, the electronic device 90 may restore the first secret key and the second secret key in the encryption key information by using the acquired ID-based secret key and certificate information, and secure the secret key by performing the XOR operation on the restored first secret key and second secret key.

In case of securing the secret key in this way, the electronic device 90 may decrypt the ciphertext by using the secret key. In this process, the electronic device 90 may recognize only the operation result rather than the plaintext state, and it is thus impossible for the electronic device 90 to know the plaintext. In addition, the SGX 132 may be operated by performing only the instructions corresponding to the open software, and it is thus impossible for the SGX 132 to perform an unnecessary operation. In addition, as described above, the software installed in the second processor core 132 may use the integrity check and a software signature key, and some of the encryption key information may use the software signature key, thus making it impossible to perform unnecessary intervention on the data.

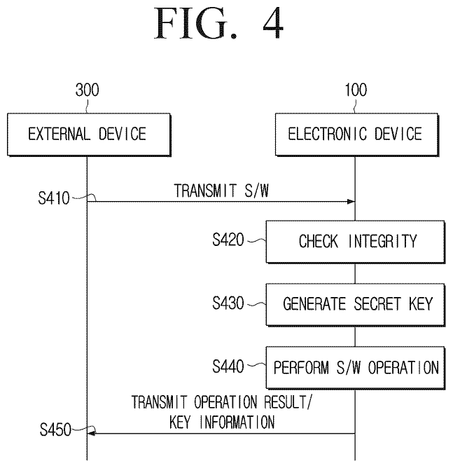

FIG. 4 is a sequence diagram for explaining an embodiment of using the open code according to the present disclosure.

Referring to FIG. 4, the external device 300 may store the open software and the various information (for example, the signature information and the hash information) corresponding to the open software. The external device 300 may be the server or electronic device of the verified company or organization, and may be open to the public for anyone to check the source code of the software. In addition, information on how the above-described signature information and hash information are created and generated using the above-described software may also be disclosed.

The electronic device 100 may receive, from the external device, the open software, the signature information corresponding to the open software, and the hash information corresponding to the open software (S410).

In addition, the electronic device 100 may check the integrity of the received open software, and store the received open software in the protection zone corresponding to the TEE function in case of confirming the integrity (S420). Meanwhile, in implementation, the electronic device 100 may store the received open software in a general zone in addition to the protection zone.

In addition, the electronic device 100 may generate the secret key corresponding to the open software (S430). Here, the electronic device 100 may request and receive the ID-based secret key from an external key management device to generate the encryption key information corresponding to the secret key. In this ID-based secret key, the above-described ID may use a hash value corresponding to the open software, or a unique value such as the serial information or code ID of the software.

The electronic device 100 may perform the operation corresponding to the open software by using the open software and the data, stored in the protection zone (S440). As such, the electronic device 100 may perform the operation by using the open software, and the open software may use the open source as described above. Therefore, it is difficult for the software to include an unnecessary malicious code. Therefore, it is difficult for the manufacturer of the CPU equipped with the TEE (or SGX) function to arbitrarily perform the malicious code.

Meanwhile, in the example shown above, the electronic device 100 is shown as being operated by receiving only one open software. However, in implementation, the electronic device 100 may also use a plurality of open software, or use an individual secret key for each open software.

In addition, the electronic device 100 may transmit the operation result to the external device 300 (S450). Meanwhile, in the example shown above, the device transmitting the software (S/W) and the device that receives the operation result are shown to be the same device. However, in implementation, the device that provides the software and the device that receives the operation result may be different devices.

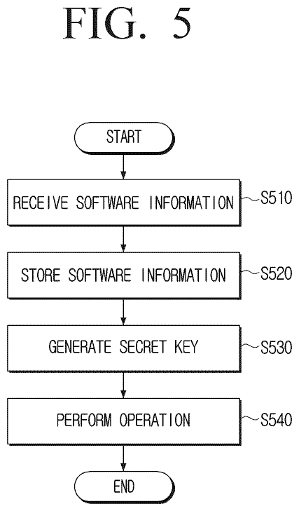

FIG. 5 is a flowchart for explaining an encryption method according to an embodiment of the present disclosure.

Referring to FIG. 5, the electronic device 100 may first receive, from the external device, the open software, the signature information corresponding to the open software, and the hash information corresponding to the open software (S510). The above-described external device may be the server of the verified external organization or company.

The electronic device 100 may store the received open software in the protection zone corresponding to the TEE (or SGX) function (S520). In implementation, the electronic device 100 may perform the integrity check for the received open software, and store only the open software whose integrity is confirmed in the protection zone.

The electronic device 100 may generate the secret key corresponding to the open software (S530). In detail, the electronic device 100 may generate the first random value and the second random value, and generate the secret key by performing the XOR operation on the two generated random values. Here, the electronic device 100 may encrypt the first random value by using the ID-based secret key, encrypt the second random value by using the signature information, and provide the same to the external device using the operation result. In this way, the electronic device 100 may encrypt the secret key by using the hybrid method, thus making the secret key quantum-resistant.

The electronic device 100 may perform the operation corresponding to the open software by using the open software and the data, stored in the protection zone. If the data is encrypted, that is, if the data is already encrypted using the open software, the electronic device 100 may perform the decryption by using the secret key, and perform the operation corresponding to the open software by using the decrypted data. As such, the electronic device 100 may perform the operation faster by performing the operation in the plaintext state. In addition, the electronic device 100 may encrypt and store the data by using the above-described secret key in a data storage process, thereby ensuring the security of the stored data.

In addition, the electronic device 100 may transmit the operation result to the external device 300 (S450). Here, the electronic device 100 may encrypt the operation result corresponding to the open software by using the secret key, and transmit the encrypted operation result. In addition, the electronic device 100 may transmit the encryption key information corresponding to the secret key together with the operation result.

Here, the encryption key information may include the first data acquired by encrypting the first secret key included in the secret key by using the private key, and the second data acquired by encrypting the second secret key included in the secret key by using the signature information.

Meanwhile, in the example shown above, the device transmitting the software (S/W) and the device that receives the operation result are shown to be the same device. However, in implementation, the device that provides the software and the device that receives the operation result may be the different devices.

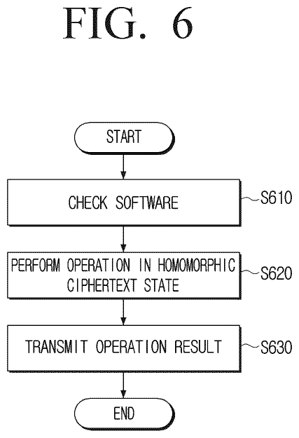

FIG. 6 is a flow chart for explaining an encryption method according to an embodiment of the present disclosure.

The electronic device 100 may first check the software for performing the operation (S610). If the software for performing the operation is the open software, the electronic device 100 may perform the same operation as described above with reference to FIG. 5.

If receiving a request for the operation of the non-open software, the electronic device 100 may perform the following operations.

In detail, the electronic device 100 may perform the operation command by using the homomorphic operation corresponding to the homomorphic ciphertext (S620).

In addition, the electronic device 100 may transmit the operation result (S630).

Meanwhile, the methods according to the various embodiments of the present disclosure described above may be implemented in the form of an application which may be installed on an existing electronic device.

In addition, the methods according to at least some of the various embodiments of the present disclosure described above may be implemented only by the software upgrade or hardware upgrade of the existing electronic device.

In addition, the methods according to at least some of the various embodiments of the present disclosure described above may be performed by an embedded server disposed in the electronic device, or at least one external server of the electronic device.

Meanwhile, according to an embodiment of the present disclosure, the various embodiments described above may be implemented by software including an instruction stored in a machine-readable storage medium (for example, a computer-readable storage medium). The machine may be a device that invokes the stored instruction from the storage medium, may be operated based on the invoked instruction, and may include the electronic device (e.g., electronic device A) according to the disclosed embodiments. In case that the instruction is executed by the processor, the processor may directly perform a function corresponding to the instruction or other components may perform the function corresponding to the instruction under the control of the processor. The instruction may include a code provided or executed by a compiler or an interpreter. The machine-readable storage medium may be provided in the form of a non-transitory storage medium. Here, the “non-transitory storage medium” may refer to a tangible device and only indicate that this storage medium does not include a signal (e.g., electromagnetic wave), and this term does not distinguish a case where data is semi-permanently stored in the storage medium and a case where data is temporarily stored in the storage medium from each other. For example, the “non-transitory storage medium” may include a buffer in which data is temporarily stored. According to an embodiment, the methods according to the diverse embodiments disclosed in the present document may be included and provided in a computer program product. The computer program product may be traded as a product between a seller and a purchaser. The computer program product may be distributed in the form of the machine-readable storage medium (for example, a compact disc read only memory (CD-ROM)), or may be distributed online (e.g., downloaded or uploaded) through an application store (e.g., PlayStore™) or directly between two user devices (e.g., smartphones). In case of the online distribution, at least a part of the computer program product (e.g., downloadable app) may be at least temporarily stored or temporarily provided in the machine-readable storage medium such as a server memory of a manufacturer, a server memory of an application store, or a relay server memory.

The various embodiments of the present disclosure may be implemented by software including the instruction stored in the machine-readable storage medium (for example, the computer-readable storage medium). The machine may be a device that invokes the stored instruction from the storage medium, may be operated based on the invoked instruction, and may include the electronic device (for example, the electronic device 100) according to the disclosed embodiments.

In case that the instruction is executed by the processor, the processor may directly perform a function corresponding to the instruction or other components may perform the function corresponding to the instruction under the control of the processor. The instruction may include a code provided or executed by a compiler or an interpreter.

Although the embodiments are shown and described in the present disclosure as above, the present disclosure is not limited to the above-described specific embodiments, and may be variously modified by those skilled in the art to which the present disclosure pertains without departing from the gist of the present disclosure as claimed in the accompanying claims. These modifications should also be understood to fall within the scope and spirit of the present disclosure.

1. An electronic device comprising:
a communication device configured to communicate with an external device;
a memory storing data; and
a processor configured to support a trusted execution environment (TEE) function,
wherein the processor is configured to:
store a received open software in a protection zone corresponding to the TEE function, when the open software, signature information corresponding to the open software, and hash information corresponding to the open software are received from the external device,
generate a secret key corresponding to the open software, and
perform an operation corresponding to the open software by using the open software and the data, stored in the protection zone.

2. The device as claimed in claim 1, wherein the processor is configured to
classify the secret key into a first secret key and a second secret key,
encrypt the first secret key by using a private key,
store the encrypted the first secret,
encrypt the second secret key by using the signature information, and
store the encrypted the second secret key.

3. The device as claimed in claim 2, wherein the secret key is calculated by an XOR operation performed on the first secret key and the second secret key.

4. The device as claimed in claim 1, wherein the processor is configured to
encrypt a received private key by using the TEE function, and
store the encrypted private key in the protection zone.

5. The device as claimed in claim 1, wherein the processor is configured to encrypt an operation result corresponding to the open software by using the secret key.

6. The device as claimed in claim 5, wherein the processor is configured to control the communication device to transmit the encrypted operation result and encryption key information corresponding to the secret key.

7. The device as claimed in claim 6, wherein the encryption key information includes
first data acquired by encrypting the first secret key included in the secret key by using a private key, and
second data acquired by encrypting the second secret key included in the secret key by using the signature information.

8. The device as claimed in claim 5, wherein the processor is configured to store the encrypted operation result and information on the open software in the memory.

9. The device as claimed in claim 8, wherein the processor is configured to
compare the information on the open software corresponding to a ciphertext with software for performing the operation in case that the data used by the open software is stored in the memory in a form of the ciphertext, and
decrypt the ciphertext by using the secret key in case that the two software are the same software.

10. The device as claimed in claim 1, wherein the processor is configured to
check integrity of the open software when the open software is received,
generate the secret key in case of confirming the integrity.

11. The device as claimed in claim 1, wherein the processor is configured to perform an operation command by using homomorphic operation corresponding to a homomorphic ciphertext in case of receiving the operation command using non-open software.

12. An encryption method of an electronic device which includes a processor configured to support a trusted execution environment (TEE) function, the method comprising:
receiving, from an external device, an open software, signature information corresponding to the open software, and hash information corresponding to the open software;
storing the received open software in a protection zone corresponding to the TEE function;
generating a secret key corresponding to the open software; and
performing an operation corresponding to the open software by using the open software and data, stored in the protection zone.

13. The method as claimed in claim 12, further comprising encrypting an operation result corresponding to the open software by using the secret key.

14. The method as claimed in claim 13, further comprising transmitting the encrypted operation result and encryption key information corresponding to the secret key.

15. The method as claimed in claim 14, wherein the encryption key information includes
first data acquired by encrypting a first secret key included in the secret key by using a private key, and
second data acquired by encrypting a second secret key included in the secret key by using the signature information.

16. The method as claimed in claim 13, further comprising storing the encrypted operation result and information on the open software in a memory.

17. The method as claimed in claim 16, further comprising:
comparing the information on the open software corresponding to a ciphertext with software for performing the operation in case that the data used by the open software is stored in the memory in a form of the ciphertext; and
decrypting the ciphertext by using the secret key in case that the two software are the same software.

18. The method as claimed in claim 12, further comprising checking integrity of the open software when the open software is received.
